(19) United States
(12) Patent Application Publication
(10) Pub. No.: US 2008/0202616 A1
(43) Pub. Date: Aug. 28, 2008

(54) Fluid Transporting Tube

(75) Inventors: Stéphane Bergere, St. Jean de Braye (FR); Alexander Korzhenko, St. Victor D'epine (FR); Henri-Jean Caupin, Versailles (FR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: ESPA, Paris (FR)

(21) Appl. No.: 11/572,865

(22) PCT Filed: Jul. 6, 2005
(86) PCT No.: PCT/FR05/01736

§ 371 Date: Aug. 21, 2007

(30) Foreign Application Priority Data
Aug. 3, 2004 (FR) 0408577

(51) Int. Cl. F16L 55/00

(52) U.S. Cl. 138/33; 138/126

(57) ABSTRACT

A fluid transport tube comprising at least an inner layer, an outer protective layer, and an intermediate temperature regulator device connected to a source of voltage and suitable for heating the transported fluid towards an equilibrium or reference temperature by using a positive temperature coefficient thermistor presenting electrical resistance that is automatically controlled by temperature and that is connected to the source of voltage via at least two conductor elements delivering the current needed for heating it, wherein each conductor element is a metal wire that is supported by a textile ply wound around the inner layer of the tube, and wherein said inner layer is based: on at least one elastomer; or on at least one thermoplastic elastomer selected from the group consisting of ionomers and olefin-based thermoplastic elastomers having a cross-linked elastomer phase.

The invention relates to a fluid transport tube that is fitted with a temperature regulator device so as to be capable of preventing the transported liquid from freezing and so as to facilitate flow thereof in the tube.

### BACKGROUND OF THE INVENTION

In general, the variation in the viscosity of a liquid with temperature constitutes a major drawback that arises with liquid flow in fluid transport tubes that are subjected to temperature variations.

### OBJECTS AND SUMMARY OF THE INVENTION

An object of the invention is to mitigate that drawback, and to this end the invention provides a fluid transport tube comprising at least an inner layer, an outer protective layer, and an intermediate temperature regulator device connected to a source of voltage and suitable for heating the transported fluid towards an equilibrium or reference temperature by using a positive temperature coefficient thermistor presenting electrical resistance that is automatically controlled by temperature and that is connected to the source of voltage via at least two conductor elements delivering the current needed for heating it, wherein each conductor element is a metal wire that is supported by a textile ply wound around the inner layer of the tube, and wherein said inner layer is based:
on at least one elastomer; or
on at least one thermoplastic elastomer selected from the group consisting of ionomers and olefin-based thermoplastic elastomers having a cross-linked elastomer phase.

Advantageously, the thermistor may be connected to the source of voltage via a plurality of conductor elements that are selectively connected to the source of voltage in order to act on the response time of the thermistor.

In general, the textile ply may be textured and made of a material such as polyamide or polyester, for example, and each conductor element may be disposed in a spiral, extending longitudinally or transversely in the textile sheet.

In an embodiment of the invention, the thermistor-forming material may be coated on the textile ply in the form of a layer of paint and over a thickness that is small, less than 1 millimeter (mm), said material being a conductive composite polymeric material.

A fluid transport tube of the invention can be used in numerous fields in industry, in particular in the automobile field for injecting a fluid such as urea for acting on the nitrogen monoxides present in the exhaust gas of a motor vehicle, in the field of aviation in order to prevent a fluid such as water freezing in the hold of an airplane, or in the field of swimming pools in order to prevent the water of a pool freezing, for example.

### BRIEF DESCRIPTION OF THE DRAWINGS

Other advantages, characteristics, and details of the invention appear from the following additional description with reference to the accompanying drawings, given purely by way of example, and in which:

FIG. 1 is a partially cutaway view of a fragment of fluid transport tube of the invention and including an intermediate temperature regulator device;

FIG. 2 is a fragmentary diagrammatic view of the intermediate temperature regulator device of FIG. 1;

FIG. 3 is a diagrammatic view of a variant embodiment of the temperature regulator device of FIG. 1; and

FIG. 4 is a simplified view of a way in which a fluid transport tube of the invention can be used in an application to treating the exhaust gas from a motor vehicle.

### MORE DETAILED DESCRIPTION

In an embodiment of the invention, the fluid transport tube 1 comprises at least an inner layer 3 optionally in contact with the transported fluid, and an outer protective layer 5. The inner layer 3 is generally made of a material that is not electrically conductive and that is compatible with potential attack from the transported fluid. The outer protective layer 5 of the tube 1 must be capable of withstanding any attack from the surrounding medium and should be made of a material presenting good thermal insulation properties, which material can be based on EPDM rubber, for example.

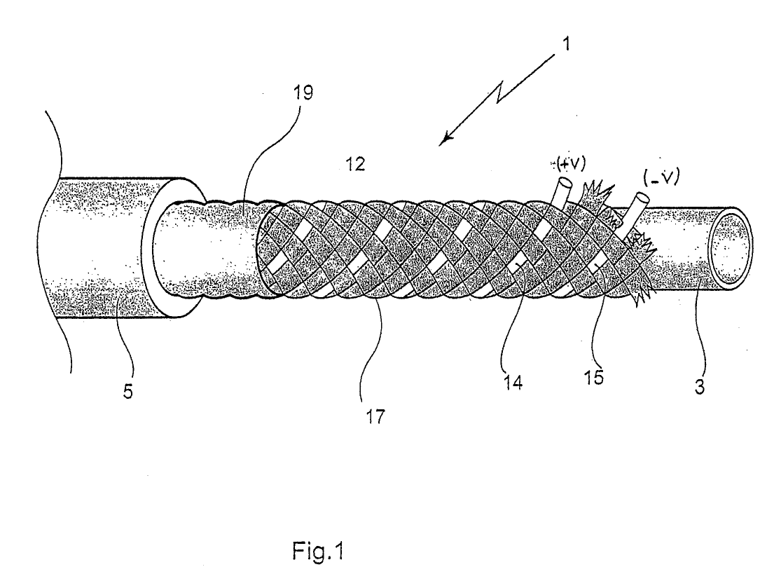

The tube 1 also includes an intermediate temperature regulator device 10 which is connected to a source of voltage that is not shown in FIG. 1. The temperature regulator device 10 comprises a thermistor 12 having a positive temperature coefficient (PTC) presenting electrical resistance that is automatically controlled by temperature (the PTC effect). More precisely, the thermistor 12 is characterized by a resistance that varies and that increases, in particular above a critical or threshold temperature. If a voltage is applied to the terminals of the thermistor at a temperature of about 0° C., for example, then the current it conveys will heat it by the Joule effect. When the temperature reaches a threshold value T₀, the resistance of the thermistor increases strongly so that any raising of the temperature above T₀ leads to a decrease in the current carried by the thermistor, and thus to a decrease in the power consumed by the Joule effect. However, any decrease in temperature below T₀ will lead to an increase in the current being carried by the thermistor, and thus to an increase in the power consumed by the Joule effect. In other words, this provides automatic control over the power dissipated by the thermistor in the vicinity of its threshold temperature T₀.

The thermistor 12 is connected to the source of voltage by at least two conductor elements 14 and 15 carrying the current needed for heating the thermistor. Each conductor element 14 and 15, e.g. in the form of a metal wire, is supported by a textile sheet 17 in the form of a braid that is advantageously textured to give it a certain amount of volume. The textile ply 17 can be made of polyamide or of polyester, for example, and it is wound on the inner layer 3 of the tube. In the embodiment of FIG. 1, the conductor elements 14 and 15 are placed in a spiral in the textile ply 17, however in a variant these conductor elements could extend either longitudinally in a direction parallel to the axis of the tube, or else transversely in a direction perpendicular to the axis of the tube.

The thermistor 12 is made of a conductive polymeric composite material, with one such material 19 being described in particular in the European patent application published under the No. EP-1 205 514. By way of example, the material 19 may comprise 40% to 90% by weight of polyvinylidene fluoride (PVDF) homopolymer or copolymer crystallized in the β form, 10% to 60% of a conductive filler, e.g. carbon black or graphite, 0 to 40% of a crystalline or semicrystalline polymer, and 0 to 40% of a filler that is different from the above filler, the above-mentioned β form crystals being nucleated on the surfaces of the particles of the conductive filler. That conductive polymeric composite material 19 is coated on the textile ply 17 in the form of a layer of paint of thickness that is small, less than 1 mm, and preferably of the order of a few tenths of a millimeter. This thickness corresponds overall to 100 grams (g) of material coated on one square meter (m²).

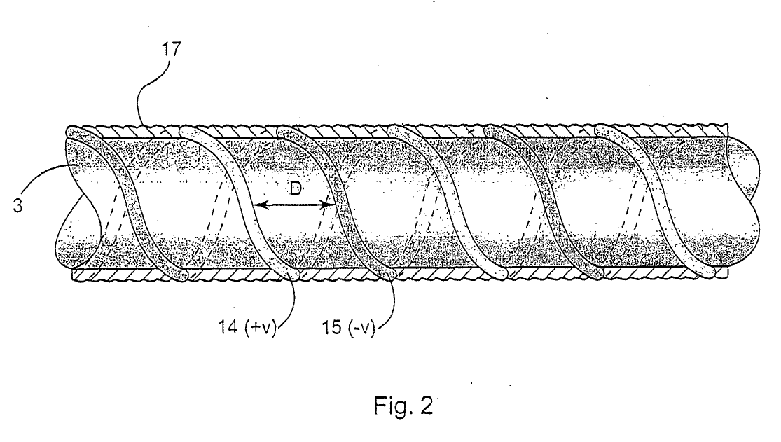

As shown in FIG. 2, the two conductor elements 14 and 15 are disposed in a spiral in the textile ply 17 and they are connected to two terminals of a source of voltage V, and the current flows through the material 19 in transverse directions as represented by arrow F between the two conductors 14 and 15 that are separated from each other by a distance D, assuming that the two conductor elements are wound in the braid 12 at a constant pitch P (P=D×2) and that they are spaced apart by a distance that is constant.

Thus, when a voltage V is applied between the two conductors 14 and 15, a current I flows in the material 19 and electrical power P is propagated into the material 19 by the Joule effect where P=RI² (R being the electrical resistance of the material), which power dissipates in particular towards the inner layer 3 of the tube, thereby heating the fluid transported by the tube 1. If the tube 1 is in an environment at a low temperature T₁, e.g. less than 0° C., the electrical resistance R of the material 19 will be low, thereby increasing the current I and thus the amount of power P that is dissipated, consequently raising the temperature of the transported fluid so as to protect it from freezing. When the temperature of the material 19 exceeds the threshold value T₀ above which its electrical resistance R increases, the current I decreases, and so does the power dissipated, thereby obtaining automatic control over the power dissipated by the material 19 around the threshold value T₀. In contrast, if the tube 1 is in an environment at a temperature T₂ significantly higher than the threshold value T₀ of the material 19, then the power dissipated will be low and will have no incidence on the value of the temperature T₂. Nevertheless, in the context of the invention, it is the first assumption of providing protection against freezing that is favored, i.e. a tube 1 is placed in a low temperature environment in order to increase the temperature of the fluid so as to ensure that its viscosity is suitable for obtaining a good flow of the fluid in the tube 1.

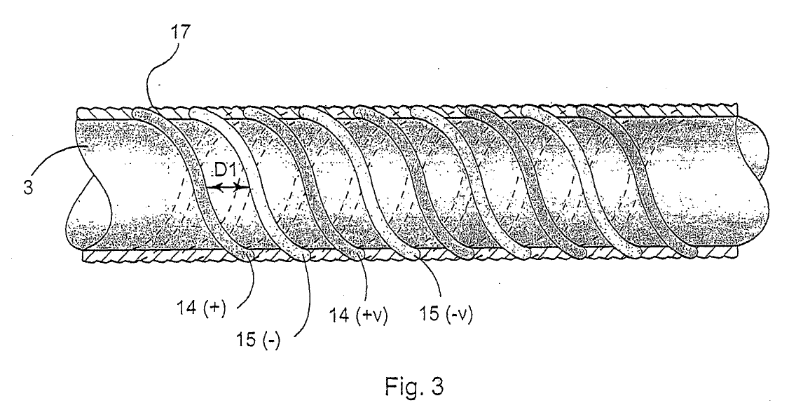

Nevertheless, as shown in FIG. 3, it is advantageous to provide a plurality of conductor elements 14 and conductor elements 15 in order to reduce the response time of the material 19. By increasing the number of conductor elements 14 and 15, the distance D₁ between two conductors 14 and 15 is reduced, thereby resulting in greater heat dissipation so as to heat the fluid more quickly. Thus, provision can be made for connecting more conductor elements 14 to the +terminal and more conductor elements 15 to the—terminal of the source of the voltage V, in particular in order to increase the power dissipated in the material 19 and reach the value of the threshold temperature T₀ more quickly.

In general, the layer 3 may be based on:
at least one elastomer, preferably selected from the group consisting of ethylene/propylene/diene (EPDM) terpolymers, silicone rubbers, fluorosilicone rubbers, fluorocarbon rubbers, ethylene/acrylate copolymers, polyacrylates, homopolymers and copolymers of epichlorhydrine, nitrile rubbers, hydrogenated nitrile rubbers, polychloroprenes, chlorosulfonated polyethylenes, polyurethanes (PUR), and mixtures of said elastomers, or
at least one thermoplastic elastomer selected from the group consisting of ionomers and olefin-based thermoplastic elastomers having a cross-linked elastomer phase, said thermoplastic elastomer preferably being a mixture of:
   a cross-linked elastomer that is synthesized by a metallocene catalyst and that belongs to the group consisting of EPDMs and polyoctenes; and
   a grafted polyolefin, such as propylene.

As an even more preferred example, said thermoplastic elastomer used in the layer 3 of the invention is a mixture of a grafted polypropylene and of a cross-linked EPDM synthesized by a metallocene catalyst, said thermoplastic elastomer advantageously being that known as “Vegaprene”.

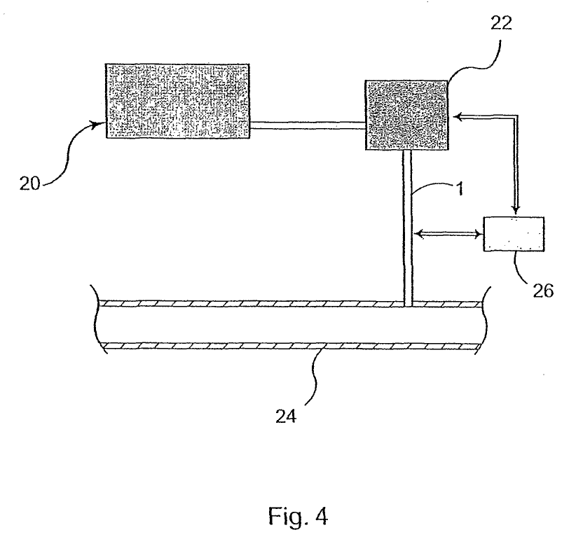

A tube 1 of the invention transporting urea may be used for example in order to treat the nitrogen oxides in the exhaust gas from a motor vehicle, as illustrated diagrammatically in FIG. 4. A tank 20 containing urea is connected to an injection pump 22 communicating with the exhaust pipe 24 via a tube 1 in accordance with the invention. On cold starting the engine, the source of voltage that feeds the two conductor elements 14 and 15 of the tube with current is the vehicle battery 26, and this leads to power being dissipated by the material 19, with the amount of power dissipated being greater or smaller depending on the temperature of the urea when the engine is started.

A tube 1 of the invention transporting water, for example, may also be used for protecting said water from freezing in an airplane hold or in a swimming pool.

The tube 1 of the invention may also have a structure other than that shown in FIG. 1, i.e. it may have additional layers without thereby going beyond the ambit of the invention, depending on the intended applications.

By way of example, the inner layer 3 of the tube 1 may have thickness lying in the range 1 mm to 10 mm, the outer layer 5 may have thickness lying in the range 1 mm to 50 mm, and the inside diameter of the tube 1 may lie in the range 5 mm to 500 mm, depending on the intended applications.

1. A fluid transport tube comprising at least an inner layer, an outer protective layer, and an intermediate temperature regulator device connected to a source of voltage and suitable for heating the transported fluid towards an equilibrium or reference temperature by using a positive temperature coefficient thermistor presenting electrical resistance that is automatically controlled by temperature and that is connected to the source of voltage via at least two conductor elements delivering the current needed for heating it, wherein each conductor element is a metal wire that is supported by a textile ply wound around the inner layer of the tube, and wherein said inner layer is based:
on at least one elastomer; or
on at least one thermoplastic elastomer selected from the group consisting of ionomers and olefin-based thermoplastic elastomers having a cross-linked elastomer phase.

2. A fluid transport tube according to claim 1, in which the thermistor is connected to the source of voltage via a plurality of conductor elements that are selectively connected to the source of voltage in order to act on the response time of the thermistor.

3. A fluid transport tube according to claim 1, in which the textile ply is a braid made of a material such as polyamide or polyester, for example.

4. A fluid transport tube according to claim 2, in which each conductor element is disposed in a spiral in the textile ply.

5. A fluid transport tube according to claim 2, in which each conductor element is disposed longitudinally in the textile ply.

6. A fluid transport tube according to claim 2, in which each conductor element is disposed transversely in the textile ply.

7. A fluid transport tube according to claim 1, in which the thermistor-forming material is disposed on the textile ply in the form of a layer of paint.

8. A fluid transport tube according to claim 7, in which the material forming the thermistor is deposited with a thickness that is small, less than 1 mm.

9. A fluid transport tube according to claim 7, in which the material forming the thermistor is a conductive polymeric composite material.

10. A fluid transport tube according to claim 1, in which the inner layer is made of a material that is not electrically conductive and that is based on said elastomer or said thermoplastic elastomer, the outer protective layer presents good thermal insulation properties and is made of a material based on an ethylene/propylene/diene terpolymer, for example, and the intermediate temperature regulator device is made in the form of a conductive polymeric composite material coated on a textile ply wound around the inner layer of the tube and supporting at least two conductor elements connected to the source of voltage to provide the current needed for heating the composite material.

11. A fluid transport tube according to claim 10, in which said inner layer is based on at least one elastomer selected from the group consisting of:
ethylene/propylene/diene terpolymers, silicone rubbers, fluorosilicone rubbers, fluorocarbon rubbers, ethylene/acrylate copolymers, polyacrylates, homopolymers and copolymers of epichlorhydrine, nitrile rubbers, hydrogenated nitrile rubbers, polychloroprenes, chlorosulfonated polyethylenes, polyurethanes, and mixtures of said elastomers.

12. A fluid transport tube according to claim 10, in which said inner layer is based on at least one olefin-based thermoplastic elastomer having a cross-linked elastomer phase.

13. A fluid transport tube according to claim 12, in which said inner layer is based on at least one thermoplastic elastomer comprising a mixture:
a cross-linked elastomer that is synthesized by a metallocene catalyst and that belongs to the group consisting of ethylene/propylene/diene terpolymers and polyoctenes; and
a grafted polyolefin, such as propylene.

14. The use of a fluid transport tube as defined by claim 1, the tube being used for injecting urea into an engine exhaust pipe to act on the nitrogen monoxides present in the exhaust gas.

15. The use of a fluid transport tube as defined in claim 1, the tube being used for protecting a fluid such as water from freezing in the hold of an airplane or in a swimming pool.
